(19) United States
(12) Patent Application Publication
(10) Pub. No.: US 2006/0152364 A1
(43) Pub. Date: Jul. 13, 2006

(54) RFID with field changeable identification

(76) Inventor: Charles A. Walton, Los Gatos, CA (US)

Correspondence Address: Charles A. Walton, 19115 Overlook Road, Los Gatos, CA, 95030, US

(21) Appl. No.: 11/025,551

(22) Filed: Dec. 30, 2004

(51) Int. Cl. G08B 13/14

(52) U.S. Cl. 340/568.1

(57) ABSTRACT

A radio frequency identification RFID system returns to a reader a string of bits which identifies a product or item. The subject RFID system is arranged to have one or more bits changeable, by bringing out from the chip one or more conductors, or by changeable internal memory. These conductors manage one or more bits on the chip. The chip has multiple external connections. One of the connections is made via the cover on a container, such as the cap on a drug bottle. If the cap is removed, the circuit is broken, or the tab is cut, and the message sent by the RFID is modified. This message modification is detected in the reader, and so tampering or premature opening prior to check out or to sale is detected. The cuttable tab circuit is also used in manufacturing, wherein an object tagged with an RFID chip and antenna, can have tabs on the RFID cut according to which stage of the manufacturing process is underway or has been completed. Cutting the tab reports the status of a product in the manufacturing process. Cutting selected tabs also modifies a tag to determine to which airport or gate a baggage item should be sent, or the bags status. Alternative to cutting is modification of the memory contents, using one of the non-volatile semiconductor memories, such as flash memory.

### SUMMARY OF INVENTION

A radio frequency identification system or RFID which responds to interrogation with a string of bits to uniquely identify a tag or whatever product bears the radio frequency tag. The tag has an antenna and a chip. The tag data contains a unique identification code and also carries information inserted during manufacturing or after manufacturing or in the field. The intentional modification can include bits to tell what the manufacturing status of the product is or a shipping destination. The modifiable information may also report whether a product has been tampered with, such as the removal of a cap from a pill bottle. A modifiable internal memory also changes the identification carried in the tag. Cutting selected tabs or modifying the memory content also modifies a tag to determine to which airport a baggage item should be sent. The tag data may also report who received the product, or the shipping date, or expiration date, of the product, or who received it, and other information.

The tag receives energy from the reader, and then returns a signal carrying data. The data is typically imposed on the return signal by disturbing the field.

An alternative method of date transmission uses a reader to interrogate the tag and a tag which bears a battery, a radio frequency oscillator, and a data modulating system, such as is used in automobile electronic door opening keys.

### BACKGROUND

Radio Frequency Identification means that objects bearing a tag can be identified at high speed without the need for contact, without concern for the dirt, blemishes, and glare which interferes with the reliability of optical system. One growing application is for identifying containers of medical pills. The tag consists of an antenna with an attached semiconductor chip. The chip modulates (also referred to as field disturbance) the field around the tag and thus reports the numerical value of the tag and hence the identification of the object.

A concern with medical containers is that people can open a bottle, insert a harmful substance, close the bottle, and the ultimate recipient is poisoned or otherwise injured. This illegal opening is called tampering. It is desirable that means be found to detect this tampering before pill consumption. This invention proposes a metallic or conducting tab on the cap of the bottle, connected to the chip attached to the bottle, so that the bit content of the RFID message is altered by breaking this tab, thus altering the identification report, and alerting the end user to the tampering.

In manufacturing, it is desirable to know the status of the individual product through multiple steps. The RFID system will report the status of specific changeable designated bits. This is accomplished by selectively breaking or cutting various tabs on the product. With breakable tabs it is possible to identify the production status of the product.

In airline tag systems, the presently used bar code label system is often unreliable, and is difficult to modify during usage. The RFID system with the improvements of this invention avoids these shortcomings.

### LIST OF FIGURES

FIG. 1 shows an example container or bottle, with attached RFID tag, and the external leads from the chip to a breakable tab.

FIG. 2 shows more details on the inside of the chip, the reader system, and the RFID antenna.

FIG. 3 shows a version of the logic timing associated with this field changeable identification system.

FIG. 4 shows an RFID system incorporating field modifiable nonvolatile memory, useful in airline baggage tag systems.

### DETAILED DESCRIPTION

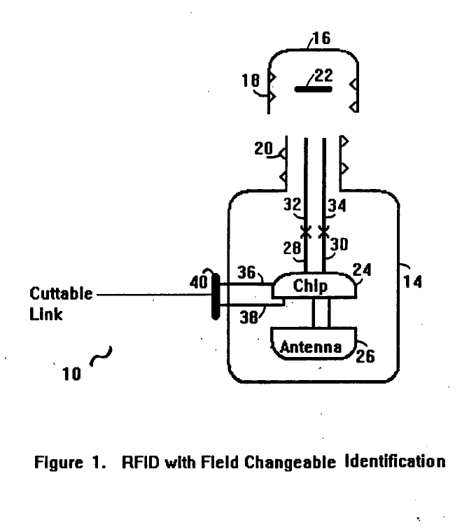

Refer to FIG. 1. The basic system 10 starts with product 14, in this case a pill bottle 14.

The bottle 14 has cap 16. The cap 16 is held in the closed position by threads 18 and threads 20 on the container 14. Mounted inside cap 16 is a shorting strip or breakable tab 22, the purpose of which is explained later.

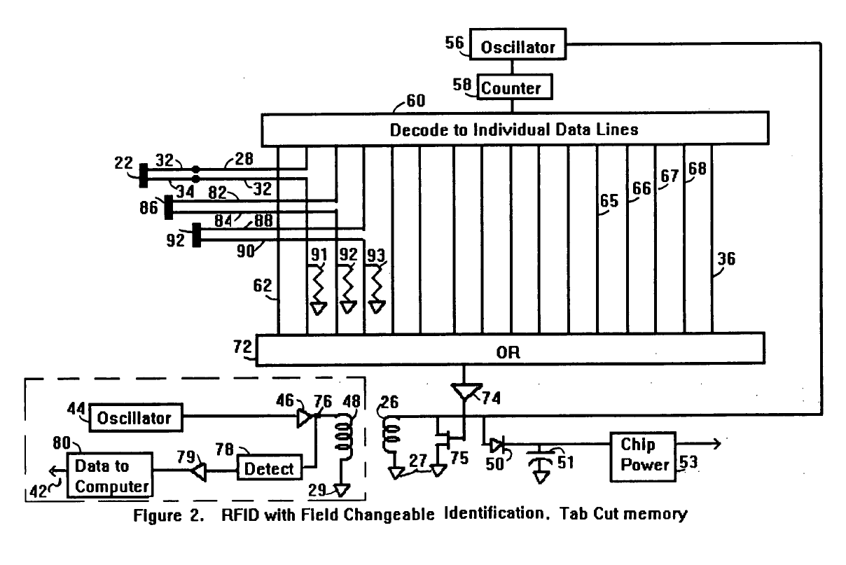

Mounted or attached to the bottle 14 is the RFID system tag composed of a chip 24 and antenna 26. The antenna 26 picks up electromagnetic signals from the reader and is comprised of a series of turns or loops. The chip 24 is connected to two terminals of the chip. The antenna 26 picks up power, and the chip rectifies the power in typical designs to get an operating DC voltage. The chip cycles through its set of data values, as described later in FIG. 2, and modulates the antenna circuit and then the antenna field with the intelligence containing the identification data. In the basic conventional form of this chip there are simply the two aforementioned chip terminals, not shown, connected to the antenna 26.

In this invention there are added conductors exiting from the chip 24. In FIG. 1 two additional conductors are elements 28 and 30. Elements 28 and 30 are extended up via elements 32 and 34 to the lip of bottle 14. At the lip they meet conductor 22, which closes the circuit between the two. Also extending from the chip 24 are supplementary conductors 36 and 38 and these are bridged by cuttable link 40.

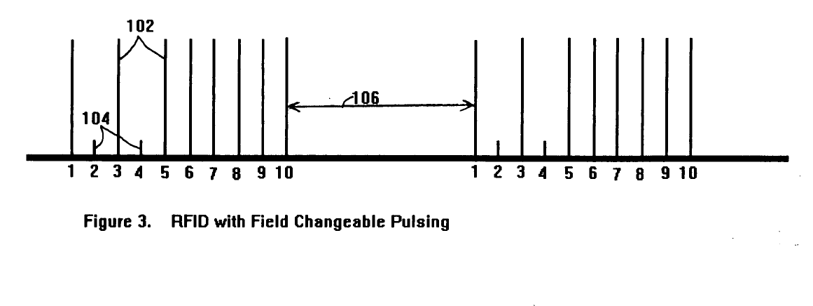

Open circuiting link 40 or tab 22 affects the identification signal, as is explained further in FIGS. 2 and 3.

FIG. 2 is a block diagram of the system. There is a Reader 42. The sequence of system action is as follows. Oscillator 42 is in the reader and generates a suitable radio frequency. Popular frequency values are 13.56 MHz, 133 KHz, 915 MHz, and 125 KHz.

The RF (radio frequency) signal passes through power amplifier 46 and excites the loop antenna 48 of reader 42. The reader 42 ground is 29, not to be confused with the floating ground 27. The RF signal is coupled by mutual inductance to Tag antenna 26. The voltage on antenna 26 is rectified by diode 50 and stored in capacitor 51 to form chip power supply 53. Oscillator 56 will start oscillating. It is optional designer's choice whether oscillator 56 chooses its own frequency or is synchronized with oscillator 44.

Oscillator 56 drives counter 58. This counter establishes the data rate and with auxiliary timing also establishes the word rate and pulse width, all of which is established engineering art. The decoder successively energizes code lines 62 through 28, 82, 84, 65, 66, 67, 68 and line 36. The code lines are either complete circuit or are open. Typically, complete lines are considered a “1” and no line a “0”. This function is also established art. Those lines which are open are referenced to ground through resistors 91, 92, 93, as in also established art.

The first line 62 is made solid. This pulse marks the beginning of the sending of a data word. (See FIG. 3 for the general appearance of the pulse stream being emitted from the system). The code lines representing a datum “1” all enter the large OR 72. The code lines representing a datum “0” do not enter the OR 72. For both datum types, time passes, so that a blank time spot is transmitted. The Data Processor or computer (not shown) recognizes a blank as a “0”. There is one line per bit plus one common line.

The ID (also referred to as the identification code) code for an individual chip is established by whether the data lines 62 through 28, 82, 84, 65, 66, 67, 68 and line 36 are open or complete. A primary part of the ID code value is entered at the time of manufacturing. This part of the code is controlled by lines 65, 66, 67, and 68 and whether they are made open or continuous at the time of manufacture.

The field changeable part of the code is established by lines 28, 82, and 88, and by their connected shorting tabs 22, 86, and 92. The shorting tabs 22, 86, and 92 are available for manipulation by the world external to the chip. If the shorting tab is continuous a “1” is transmitted; if open a “0” is transmitted (or the inverse). The RFID unit is shipped with the tabs 28, 86, and 88 continuous. The user of the chip has the option of opening these tabs. The user may manually cut the tabs, or may machine cut the tabs. Thus the user has post-manufacturing control of parts of the identification message, and may allocate one or more tabs to the function of detecting improper delivery of the product, including detecting some person having opened and tampered with the contents of a container of drugs. Needless to say, the quantity of field changeable bits is not restricted to three, but may be any portion of the entire ID message.

The output of OR 72 enters modulator circuit 74. Modulator 74 passes on the pulse stream to field effect transistor 75 (or a circuit equivalent to a field effect transistor FET 75) for affecting the loading on loop antenna 26. FET 75 applies a grounding short circuit to antenna 26, and this impacts the electromagnetic field existing between reader antenna 48 and tag antenna 26. This impact phenomenon is referred to in the art as “field disturbance”.

The top of antenna 48 is point 76. The field disturbance effect produces a modulation ripple at point 76. The ripple is captured from the driving voltage on point 76 using a conventional detector 78, which is established art, although at a higher than usual detector voltage. This signal is amplified by amplifier 79 to pulse levels and passed on to communication link 80 and to later data processing. The modulating logic, which blends time pulses and data pulses, is state of the art. To blend data and timing signals it may use one form of encoding known as Manchester encoding.

FIG. 3 shows one form of the data transmission message. The message 100 as shown has a tall pulse 102 for all “1” data cells. The low height or zero height pulses 104 and 105 in cells 2 and 4 represent zeros “0”. Note that after a cycle of ten values, the data is followed by a timing gap 106, and then the data is repeated. Protection against noise interference and loss of data is achieved by reading multiple repetitions of the signal, and protection against noise is also achieved by conventional error detection and error correction logic.

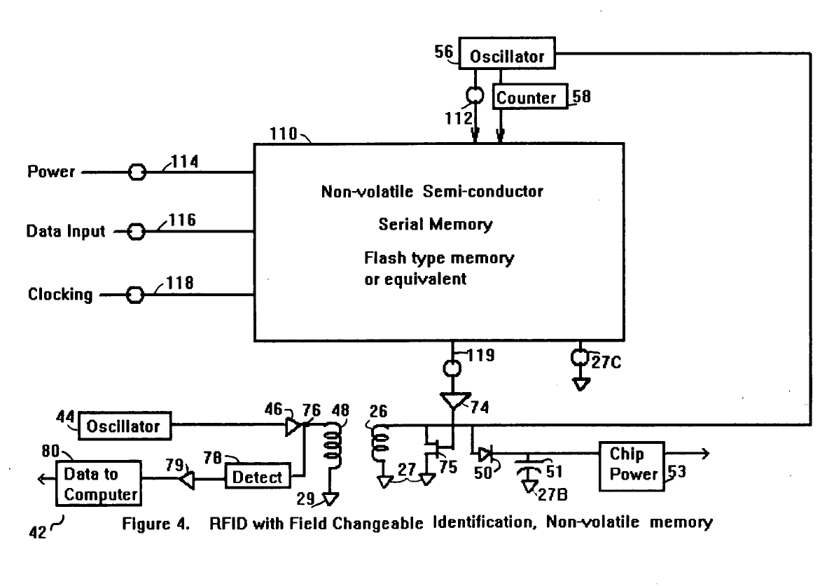

In FIG. 4 is shown an implementation of memory suitable as an option for an airline baggage tag system. The data content of the tag is field modified or controlled by loading new ID into the Tag. The memory 110 is a semi-conductor carrying a non-volatile series of data bits. One version of such a memory is known as “flash” memory. The non-volatile memory is loaded with data either while the Tag is stationery, using the contact pads as shown, or with more advanced tag design in which by using RF inductive coupling to replace the functions applied to terminals 114, 116 118 and 112, the tag memory is modified while the tag is in motion. When loading the memory the circular connection pads shown are energized. These pads include: external power 114, data input 116, and clocking 118. The oscillator input pad 112 aids memory loading. There is necessarily a ground pad also. The memory 110 is read out via connection 119 to the modulation system to output 80 at any number of convenient reading stations. This traveling memory is alternative to and cooperative with central memory at the airport, which tracks the movement of all bags.

Typical memory content might be city of destination, such as NYC, JFK, SJO, or SFO. Destination might also be the gate or loading station or conveyor or van for the next departing flight. The content may also include passenger ID, ticket number, and whether the suitcase has been inspected for explosives. This memory content may or may not be supplemented with memory introduced by cutting tabs, as in FIG. 2.

1. A radio frequency identification system with changeable message, comprising a reader device and a radio frequency sensitive tag, which operates with power derived from the reader, in which there is an identification message in the form of a series of pulses controlled from within the tag, in which said series of pulses comes primarily from data stored within circuits of said tag, and in which portions of said message can be modified by manipulation of external conductors on the tag or by changes in internal memory.

2. A radio frequency identification system with changeable message as in claim 1 in which said memory modification is by not cutting or cutting a multiplicity of conductors external to the circuits of said tag.

3. A radio frequency identification system with changeable message as in claim 2 in which said cutting or not cutting is utilized to report the status of a product in the manufacturing process.

4. A radio frequency identification system with changeable message as in claim 2 in which said container contains pharmaceutical products and improper entry and insertion of poison or improper contents may cause bodily harm, and tampering with the pharmaceutical container causes a cutting or breaking of a conductor to occur, and thus reports tampering with said pharmaceutical container.

5. A radio frequency identification system with changeable message as in claim 2 in which said conductors are in the cap of the said container, and removing said cap accomplishes cutting of conductors mounted in said cap.

6. A radio frequency identification system with changeable message as in claim 2 in which said cutting or not cutting is done through manual manipulation.

7. A radio frequency identification system with changeable message as in claim 2 in which said cutting or not cutting is accomplished with automatic machinery.

8. A radio frequency identification system with changeable message as in claim 1 in which said memory is carried in a nonvolatile semiconductor memory chip.

9. A radio frequency identification system with changeable message as in claim 8 in which said memory is modified while the tag is stationary.

10. A radio frequency identification system with changeable message as in claim 8 in which memory is modified while the tag is moving.

11. A radio frequency identification system with changeable message as in claim 1 in which said memory is modified to determine to which airport or exit point a baggage item should be sent.
